(19) United States
(12) Patent Application Publication
(10) Pub. No.: US 2008/0219714 A1
(43) Pub. Date: Sep. 11, 2008

(54) SYSTEM, METHOD AND APPARATUS FOR ELECTROSTATIC IMAGE TRANSFER

(75) Inventors: Dale R. Mashtare, Bloomfield, NY (US); Christopher Snelling, Pittsford, NY (US)

Correspondence Address: OLIFF & BERRIDGE, PLC., P.O. BOX 320850, ALEXANDRIA, VA, 22320-4850, US

(73) Assignee: XEROX CORPORATION, Stamford, CT (US)

(21) Appl. No.: 11/683,054

(22) Filed: Mar. 7, 2007

(51) Int. Cl. G03G 15/01

(52) U.S. Cl. 399/302

(57) ABSTRACT

An imaging system, method and apparatus for producing an image by sensitizing a charge retentive surface of a photoreceptor, image-wise exposing the charge retentive surface to produce an electrostatic latent image, and then transferring the latent image away from the photoreceptor. An intermediate transfer belt carries the latent image to a proximally located development assembly to accommodate deposit of a toner complex onto the latent image to produce a toned image. The toned image is carried to a proximally located toner image transfer assembly that is located a distance from the photoreceptor. The toned image is transferred or transfused to a media carried by a toner image transfer belt located proximally to the intermediate transfer belt.

### BACKGROUND

The exemplary embodiments are directed to an electrostatic image transfer apparatus, and a system and a method of transferring electrostatic images in an imaging device.

Electrostatic imaging and printing processes are comprised of several distinct stages. These stages may generally be described as (1) charging, (2) imaging, (3) exposing, (4) developing, (5) transferring, (6) fusing and (7) cleaning. In the charging stage, a uniform electrical charge is deposited on a charge retentive surface, such as, for example, a surface of a photorecentor, so as to electrostatically sensitize the surface.

Imaging converts an original, or digital image into a projected image on the surface of the photoreceptor and the image is then, exposed upon the sensitized photoreceptor surface. An electrostatic latent image is thus recorded on the photoreceptor surface corresponding to the original, or digital image.

Development of the electrostatic latent image occurs when charged toner particles are brought into contact with this electrostatic latent image, The charged toner particles will be attracted to either the charged or discharged regions of the photoreceptor surface that correspond to the electrostatic latent image, depending on whether a charged area development (CAD) or discharged area development (DAD, more common) is being employed.

In the case of a single step transfer process, the photoreceptor surface with the electrostatically attracted toner particles is then brought into contact with an image receiving surface, i.e., paper or other similar substrate. The toner particles are imparted to the image receiving surface by a transferring process wherein an electrostatic field attracts the toner particles towards the image receiving surface, causing the toner particles to adhere to the image receiving surface rather than to the photoreceptor. The toner particles then fuse into the image receiving surface by a process of melting and/or pressing. The process is completed when the remaining toner particles are removed or cleaned from the photoreceptor surface.

Hence, in the related art, electrostatic imaging and printing processes occur on the charge retentive surface, e.g., photoreceptor, as shown in FIG. 5. As such, the photoreceptor, typically a multilayered light sensitive semiconductor that must be able to retain charge at high levels, is subject to continuous mechanical abrasion due to the development, cleaning, and media contact processes as well as thermal fluctuations resultant of the transferring and fusing process. Further, debris collected on the photoreceptive layer results not only in diminished print quality, but requires regular maintenance.

### SUMMARY

It would be advantageous to provide an imaging device that maintains, enhances or improves the quality of prints and the speed of printing, and extends the life expectancy of the photoconductive layer. To address or accomplish these advantages, advantages described below, and/or other advantages, the exemplary embodiments may include at least one module including a photoreceptor assembly, an intermediate transfer assembly adjoining the photoreceptor assembly, a developer assembly disposed adjacent to the intermediate transfer assembly, a cleaning assembly positioned adjacent to the intermediate transfer assembly, and a toner image transfer assembly located distally from the photoreceptor assembly, the toner image transfer assembly and the photoreceptor assembly being interposed by the intermediate transfer assembly. More specifically, the exemplary embodiments may include an electrostatic imaging device having a photoreceptor on which an electrostatic latent image is created, and may have a separate intermediate charge receptive device with developer station, transfuser station, cleaning station and/or other devices operated in conjunction with this separate intermediate charge receptive device such that these functions are removed from the photoreceptor surface.

Exemplary embodiments are described herein with respect to architectures for xerographic or electrophotographic print engines. However, it is envisioned that any imaging device that may incorporate the features of the electrostatic imaging apparatus described herein are encompassed by the scope and spirit of the exemplary embodiments.

### BRIEF DESCRIPTION OF THE DRAWINGS

FIG. 1 is a plan view of a single module in an imaging device of an exemplary embodiment;

FIG. 2 is a plan view of a multicolor tandem configuration of an imaging device of an exemplar embodiment;

FIG. 3 is a flowchart illustrating a method of image transfer in an exemplary embodiment;

FIG. 4 is a flowchart illustrating a method of multicolor image transfer in an exemplary embodiment; and

FIG. 5 is a plan view of an imaging device in the related art.

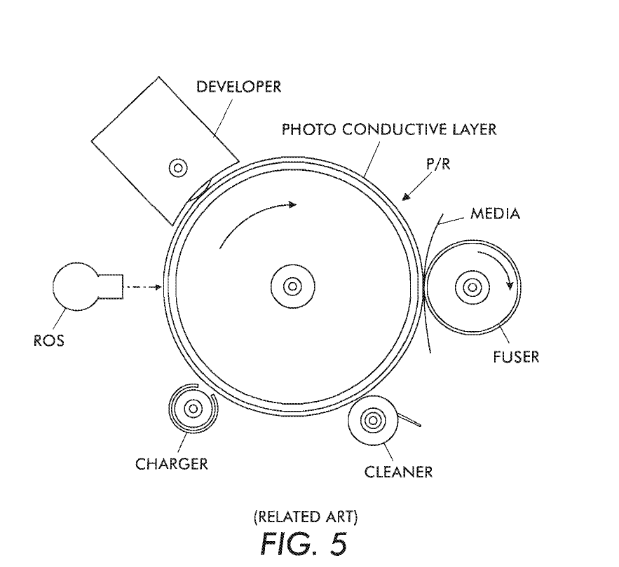

### DETAILED DESCRIPTION OF EMBODIMENTS

The exemplary embodiments are intended to cover all alternatives, modifications and equivalents as may be included within the spirit and scope of the devices, methods and systems as defined herein.

For an understanding of the system, method and apparatus for electrostatic image transfer reference is made to the drawings. In the drawings, like reference numerals have been used throughout to designate similar or identical elements. The drawings depict various embodiments of illustrative electrophotographic printing machines incorporating the features of the exemplary embodiments therein. As shown, the drawings schematically depict the various components of electrophotographic printing machines that have the various features. In as much as the art of electrophotographic printing is well known, the various processing stations employed in the printing machines will be schematically shown herein and their operation described with reference thereto.

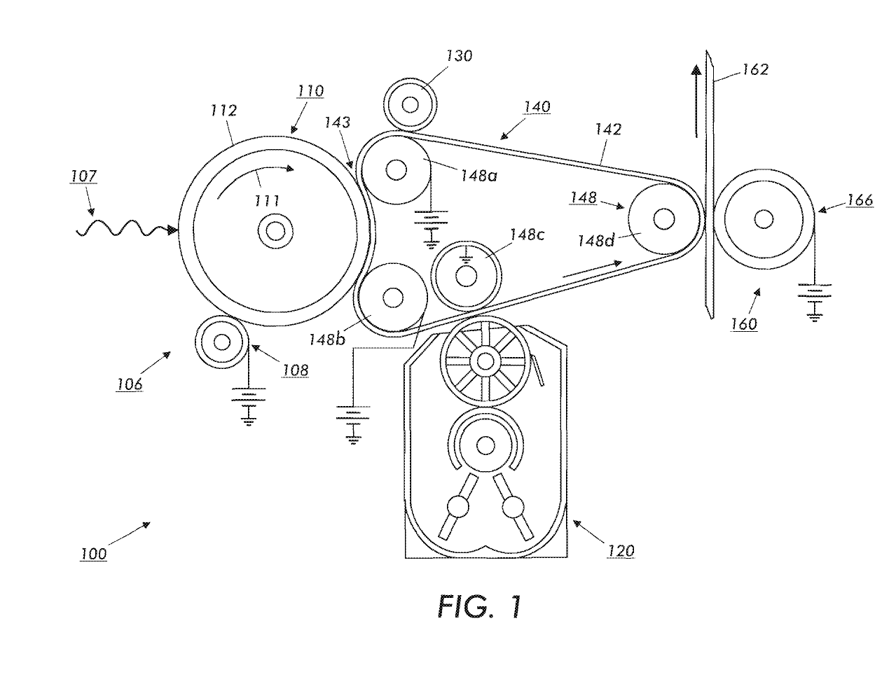

Referring now to FIG. 1, one embodiment of an image transfer apparatus includes a module 100 having an photoreceptor assembly 106, a development assembly 120, a cleaning assembly 130, an intermediate transfer assembly 140, and a toner image transfer assembly 160. These features are discussed in more detail below.

Photoreceptor assembly 106 includes a charge unit 108 and a photoreceptor 110. The photoreceptor 110 is illustrated in the shape of a roll. However, the photoreceptor 110 may alternatively be a belt, in any shape, or constitute any known or later developed device that may be electrostatically charged so that it may carry and transfer an electrostatic image, as discussed in more detail below. In the embodiment of FIG. 1, the photoreceptor 110 is mounted rotatably on a carriage (not shown) that translates in the direction of arrow 111. As the photoreceptor 110 translates in the direction of arrow 111, it rotates about its longitudinal axis in the direction of arrow 111.

Similarly, the charge unit 108 is mounted rotatably on a carriage (not shown) that translates with the photoreceptor 110 so as to charge successive portions of a photoconductive layer 112 of the photoreceptor 110 to a relatively high, substantially uniform potential. While the charge unit 108 is depicted as a bias charging roll, alternatively this could be replaced by other charge devices such as a stationary charge corotron or scorotron device.

The photoreceptor 110 continues to rotate progressing the uniformly charged regions of the photoconductive layer 112 toward the region of the exposure system 107, which interacts with the photoconductive layer 112. The charged portion of the photoconductive layer 112 may be illuminated by a light image front an exposure system 107 thereby selectively discharging the charged portion of the photoconductive layer 112 so as to form an electrostatic latent image thereon. This latent image is carried on the surface of the photoreceptor 110 to the intermediate transfer assembly 140.

The intermediate transfer assembly 140 may include a transfer belt 142 and transfer rolls 148a-d that may be biased. The transfer belt 142 may be disposed so as to be supported by the biased transfer rolls 148a-d. As shown in FIG. 1, the transfer belt moves in a direction shown by arrow 113 as the biased transfer rolls 148a-d rotate in a direction opposite to that of the photoreceptor roll 110. The transfer belt 142 may be supported by the transfer rolls 148a-d in a substantially circular shape, a substantially triangular shape (as shown in FIG. 1), in a substantially straight line, or in any other shape. Furthermore, the transfer belt may be a layer supported by a single roll. The transfer belt 142 may be any shape or form that may be constructed to accommodate the transfer of an electrostatic image, thereby allowing greater retention of image fidelity as created on the photoreceptor and as compared to that enabled with toner transfer techniques. The transfer belt 142 may be composed of materials that allow for increased temperatures while maintaining the required dielectric properties. Thus, the transfer belt 142 may be a dielectric belt composed of polymers with biasing applied at required locations with any number of the transfer rolls 148a-d as backing electrodes. Alternatively, the transfer belt 142 may include an electrode backed belt. In yet another alternative embodiment, as discussed above, the transfer belt 142 may be formed in the shape of a roll.

The transfer belt 142 and the photoconductive layer 112 of the photoreceptor 110 form an electrostatic image transfer nip 143. A myriad of configuration options for a region of the electrostatic image transfer nip 143 may be used. This may include conductive or semiconductive backed dielectric layers on the transfer belt 142 with pressure application or dielectric layers with biasing devices applied for field application to promote charge transfer. The transfer rolls 148a-b may be differentially biased so as to tailor the electrostatic field applied in this nip formed between the transfer belt 142 and the photoconductive layer 112, thereby achieving optimal conditions for electrostatic image transfer. Electrostatic image transfer is known to produce latent image resolution retention as high as 90 lines per millimeter and is thus capable of high image fidelity generation/retention. In an alternative embodiment, dimensions and torque loading of the photoreceptor roll can be minimized, and thus friction may drive the photoreceptor roll with the transfer belt 142, which may alleviate registration concerns in the nip region. The transfer belt 142 may have electrical properties that enable varied electrostatic fields about its circumferential working surface and may have a conductive layer or, in an alternative embodiment, a semiconductive layer. In yet another alternative embodiment, the transfer belt 142 may be constricted of a belt material selected to provide electrically relaxable properties whereby electrostatic fields are imparted by backing rolls, corresponding transfer or developer rolls or a cleaning device.

As the photoconductive layer 112 having a latent image retained thereon translates through nip region 143, the latent image may be transferred to the transfer belt 142 of the intermediate transfer assembly 140, which is disposed remotely from the photoreceptor 110. As the transfer belt 142 translates, the latent image carried thereby may be passed to an area of the development assembly 120.

Charged toner particles may be deposited by the development assembly 120 in a charged area of the image on the transfer belt 142 to define a visible toned image that corresponds to the latent image. The toned image may thus be defined on the transfer belt 142 in an area not in contact with the photoconductive layer 112 to reduce, minimize, and/or eliminate contact of the photoconductive layer 112 with the development assembly 120. Alternatively, toner charge polarity and biasing schemes may be employed to result in a toned region corresponding to the non-charged regions of the transfer belt 142.

The toner image may then be carried by the transfer belt 142 to an area of the toner image transfer assembly 160. The toner image transfer assembly 160 may include a toner image transfer belt 162 and at least one transfer roller 166. The toner image transfer belt 162 is constructed for the carriage of media, such as, for example, paper, or any other medium that can carry an image, not shown in FIG. 1. One of the transfer rolls, for example, transfer roll 148d, shown in FIG. 1, may form a transfer nip 115 with the transfuse roll 166. The toner image transfer belt 162 translates about transfer roller 166 to synchronously bring the media into contact with transfer belt 142 at the transfer nip 115 and the toner image retained thereon. In one exemplary embodiment, transfer roller 166 may be connected to a power supply. In such an embodiment, transfer roller 166 would be an electrostatic charge roll that would apply some pressure in electrostatic fields to apply bias to the back side of the media which would then attract the charged toner particles toward the media surface.

In an alternative embodiment, transfer roller 166 could be a heated fuser roll for thermally transferring the toner to the paper. Additionally, one of transfer rolls 148a-d located proximally to heated transfuse roll 166, such as transfer roll 148d shown in FIG. 1, could include a heating element to effect preheating of the toner as it comes into contact with the medium carried by the toner image transfer belt 162.

Pressure and heat applied to the toner and media at the transfuse nip 115 by the transfer roll 148d and the transfer roller 166 may assist in transferring the image from the transfer belt 142 to the medium. In one embodiment, a post fusing step may be employed to increase or decrease gloss level, fix level or adjust other properties of the fused images. Following the transfer of toner particles from transfer belt 142 to the medium carried by toner image transfer belt 162, transfer belt 142 translates to pass a region of the cleaning assembly 130. Additionally, thermal control devices could be included to maintain transfer belt temperatures throughout the subsequent processes.

Cleaning assembly 130 may, for example, be a wiper blade or brush or other device that cleans any residual toner, paper fibers and/or debris, etc., from the transfer belt 142. In an alternative embodiment, a cleaning assembly and means for erasing charge, currently known or later developed, may be arranged around photoreceptor 110.

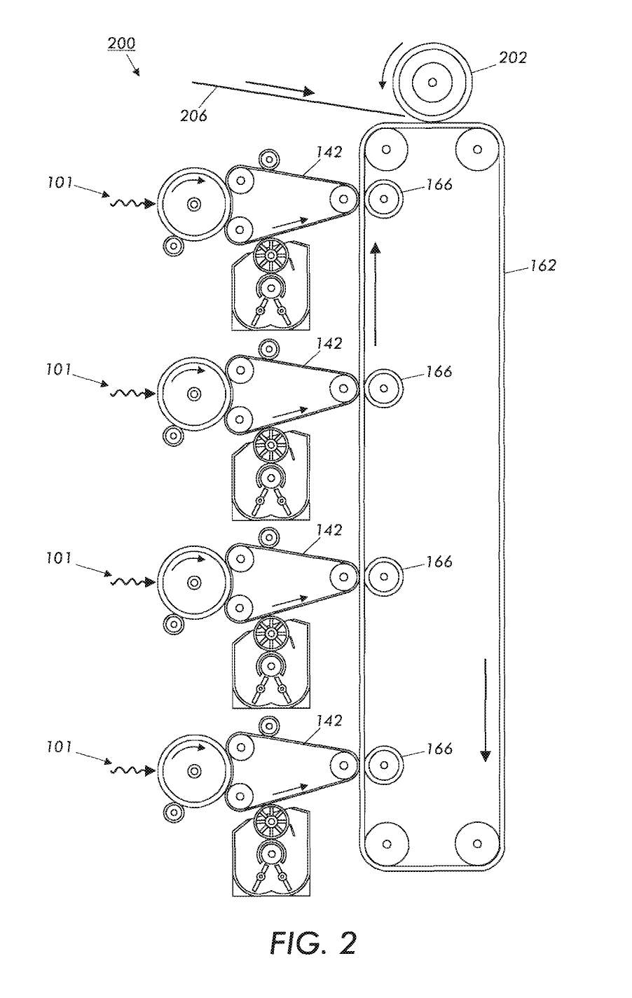

Referring now to FIG. 2, a multicolor tandem assembly 200 is shown. Multicolor assembly 200 may include a multitude of modules 101, which may correspond to the configuration of module 100 at FIG. 1 and corresponding transfer rollers 166. Each of the modules 101 may apply toner having a specified color pigment, including, for example, cyan, magenta, yellow and black colorants as commonly applied for four color process printing. Paper or other media may be fed through a media feed 206 via a media roller 202 and carried therefrom by toner image transfer belt 162. Toner image transfer belt 162 translates about transfer rollers 166 to bring media carried thereon sequentially into contact with modules 101 whereby layers of specified pigment are applied to the media to produce a color image.

In yet another alternative embodiment, toner may be transferred directly to intermediate belt 162 in successive applications of toner that may have varying pigment. The multi-pigment image may then be transferred to media via the nip formed with the belt 162 and the roll 202. Such a configuration could also employ alternative transfer or transfuse configurations. For example, such configurations could accommodate electrostatic transfer from transfer belt 142 to toner image transfer belt 162 and subsequent electrostatic transfer to media from toner image transfer belt 162. Alternatively, the subsequent transfer from the toner image transfer belt 162 could be by heat and pressure transfer to media. Yet a further embodiment could employ heat and pressure transfer from the transfer belt 142 to the toner image transfer belt 162 and subsequent heat and pressure transfer from the toner image transfer belt 162 to media.

For example, as discussed above with respect to the embodiment of FIG. 1, each of the modules 101 of the multicolor assembly 200 of the embodiment of FIG. 2, has a photoreceptor assembly 106, a development assembly 120, a cleaning assembly 130, an intermediate transfer assembly 140, and a toner image transfer assembly 160. The photoreceptor assembly 106 includes a photoreceptor 110 with a photoconductive layer 112 which is charged. The charged portion of the photoconductive layer 112 may be illuminated by a light image from an exposure system 107 which is disposed about an area of the photoreceptor 110. After the exposure system 107 forms an electric static latent image on the photoconductive layer 112, the latent image is carried on the photoconductor layer 112 toward the intermediate transfer assembly 140, which is disposed adjacent to the photoreceptor 110.

The photoconductive layer 112 having the latent image thereon translates through the nip region 143 defined by the photoconductive layer 112 and the transfer belt 142 of the intermediate transfer assembly 140. Here, the latent image is transferred to the transfer belt 142. Once the latent image is carried by the transfer belt 142, the latent image may then be developed and then transfused to a medium that serves as output. According to the exemplary embodiments, the developing and the transfusing of the image is conducted on the surface of the transfer belt 142. Thus, the photoreceptor, with the photoconductive layer 112, is not subject to the developing and transfusing process. Similarly, the cleaning of excess toner, paper fibers, and/or other debris, occurs at the transfer belt 142, which further protects the photoconductive layer 112 of the photoreceptor from excessive use and damage.

According to the embodiment of FIG. 2, each of the modules 101 having a specified pigment, produces an image on a medium, such as paper in that specified pigment. For example, a first module 101 of the multitude of modules 101 may produce an output having the color magenta, while a second module 101 of the multitude of modules 101 may produce a second color image, such as a yellow image, which is applied directly to the first image having, for example, the color of magenta. The medium may be subject to receiving images from any number of modules having a specified pigment in order to produce a desired color image.

In yet another embodiment, the medium, such as paper, may be subject to duplex printing. That is, after the appropriate single color, or multicolor image is transferred to the medium, the medium may be flipped and transferred again to the toner image transfer assembly such that images are produced on both sides of the medium.

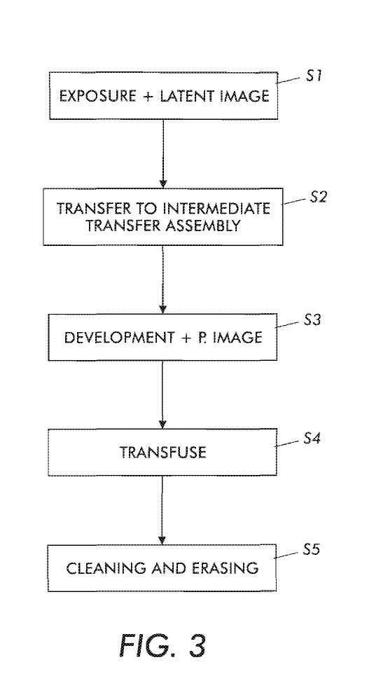

Referring to FIG. 3, a method of electrostatic image transfer is shown. The method includes exposing an electrostatic latent image produced by sensitizing a charge retentive surface such as, for example, a photoconductive layer of a photoreceptor as shown in step S1. The charge retentive surface or photoconductive layer may be charged by, for example, a charge unit to sensitize the surface. After exposure to generate the electrostatic latent image, as discussed above, the latent image is then carried to a transfer region to be transferred via a nip, as shown in transfer step S2, to an intermediate transfer assembly. The intermediate transfer assembly allows for any further processing of the image to be conducted away from the photoconductive layer.

The intermediate transfer assembly may include, for example, a transfer belt, a transfer drum, or other device constructed to accommodate receipt of the electrostatic latent image from the photoreceptor, as discussed above. The latent image may then be developed, away from the photoconductive layer as shown in development step S3, to produce a toned image. The development step may include application of a toner complex via electrostatic forces to the latent image. The toned image may then be transferred to media, as shown in transfuse step S4, by way of, for example, a transfuse process as discussed above, which is disposed a distance from the photoconductive layer. The transfuse step may include heat assisted mechanical transfer of the toned image to media carried by the toner image transfer belt.

The transfusion of the toned image from the transfer belt to the media is accomplished a distance away from the photoreceptor to guard or protect the photoconductive layer from the heat and pressure used to transfuse the image to the media. In an exemplary embodiment, the distance between the photoreceptor and the toner image transfer assembly is at least as long as the intermediate transfer assembly disposed between the photoreceptor and the toner image transfer assembly.

An alternative embodiment may include a transfer belt arranged about an electrostatic charge roll that would apply pressure in and electrical bias to the back side of the media, imparting an electrostatic field which would then attract the charged toner particles toward the media surface. The intermediate transfer assembly may then be cleaned, as shown in cleaning and erasing step S5.

The cleaning and erasing of the intermediate transfer assembly includes cleaning the transfer belt 142 with a brush, blade, or any other device that removes excess unused toner, paper fibers, debris and the like from the transfer belt 142. The cleaning of the transfer belt 142 occurs a distance from the photoconductive layer 112 and photoreceptor 110 to reduce and/or minimize wear and use of the photoconductive layer. For example, the transfer belt 142 may be cleaned following the transfuse step S4 near the toner image transfer assembly 160, or in any area between the toner image transfer assembly 160 and photoreceptor 110, preferably a distance from the photoreceptor 110.

After the cleaning and erasing step S5, the transfer belt may be used again and the process repeated.

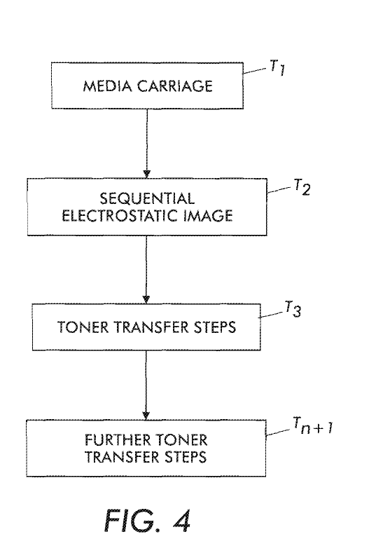

Referring to FIG. 4, a method of multicolor image production is shown. As shown in media carriage step T1, media is added and carried by an imaging system past a first module for application of a toner image. As shown in sequential toner image step T2, a toner image produced by the method discussed above with regard to FIG. 3 is applied to the media. The method includes exposing an electrostatic latent image produced by sensitizing a charge retentive surface such as, for example, a photoreceptor. The charge retentive surface or photoreceptor may be charged by, for example, a charge unit to expose the sensitized surface. After exposure of the electrostatic latent image, as discussed above, the latent image may then be transferred to an intermediate transfer assembly.

The intermediate transfer assembly may include, for example, a transfer belt constructed to accommodate receipt from the photoreceptor 110 of the electrostatic latent image, as discussed above. The latent image in may then be developed, away from the photoconductive layer, to produce a toned image. The development step may include application of a toner complex via electrostatic forces. The toned image may then be transferred to media by way of a transfuse process as discussed above, in which the transfuse step occurs a distance away from the photoconductive layer. The transfuse may include heat and/or pressure assisted mechanical transfer of the toned image to media carried by the toner image transfer belt 162.

The transfusion of the toned image from the transfer belt to the media is accomplished a distance away from the photoreceptor to guard or protect the photoconductive layer from the heat and pressure used to transfuse the image to the media. In an exemplary embodiment, the distance between the photoreceptor 110 and the toner image transfer assembly 160 is at least as long as the intermediate transfer assembly disposed between the photoreceptor 110 and the toner image transfer assembly 160.

An alternative embodiment may include a toner image transfer belt arranged about an electrostatic charge roll that would apply pressure and electrostatic fields via an applied bias to the back side of the media, which would then attract the charged toner particles toward the media surface. The intermediate transfer assembly may then be cleaned.

The cleaning and erasing of the intermediate transfer assembly includes cleaning the transfer belt 142 with a brush, blade, or any other device that removes residual toner, paper fibers, debris and the like from the transfer belt 142. The cleaning of the transfer belt 142 occurs a distance from the photoconductive layer 112 and photoreceptor 110 to reduce and/or minimize wear and use of the photoconductive layer. For example, the transfer belt 142 may be cleaned following the transfuse step S4 near the toner image transfer assembly 160, or in any area between the toner image transfer assembly 160 and photoreceptor, and a distance away from the photoreceptor. In an alternative embodiment, a cleaning assembly 130 and means for erasing charge could be arranged around photoreceptor 110.

After the cleaning and erasing step S5, the transfer belt may be used again and the process repeated.

Following application of a toner image to media by a first module, the media may then be carried to a second module. As shown in the toner transfer step of T3, a toner image produced by the method discussed above and having different pigment than that of the toner image in step T2 is applied to the media by the second module. The toner images on the media are applied in an aligned manner to produce a multicolor image. The method of FIG. 4 may include further toner transfer steps T3 through Tn+1. In an alternative embodiment, a duplex imaging arrangement may be provided for applying toner transfer steps to a reverse side of media.

For purposes of explanation, in the above description, numerous specific details were set forth in order to provide a thorough understanding of the image transfer method, system and apparatus. It will be apparent, however, to one skilled in the art that image transfer as described above can be practiced without the specific details. In, other instances, well-known structures and devices are shown in block diagram form in order to avoid obscuring the image transfer method, system and apparatus described.

While image transfer has been described in conjunction with specific embodiments thereof, it is evident that many alternatives, modifications, and variations will be apparent to those skilled in the art. Accordingly, embodiments of the method, system and apparatus as set forth herein are intended to be illustrative, not limiting. There are changes that may be made without departing from the spirit and scope of the exemplary embodiments.

It will be appreciated that various of the above-disclosed and other features and functions, or alternatives thereof, may be desirably combined into many other different systems or applications. Also, various presently unforeseen or unanticipated alternatives, modifications, variations or improvements therein may be subsequently made by those skilled in the art, and are also intended to be encompassed by the following claims.

1. An imaging device comprising:
a module including a photoreceptor assembly and an intermediate transfer assembly disposed adjacent to said photoreceptor assembly; and
a toner image transfer assembly located distally from said photoreceptor assembly, said toner image transfer assembly and said photoreceptor assembly; being interposed by said intermediate transfer assembly.

2. The imaging device of claim 1, the intermediate transfer assembly including a developer assembly disposed remotely from said photoreceptor assembly.

3. The imaging device of claim 1, the intermediate transfer assembly including a cleaning assembly disposed remotely from said photoreceptor assembly.

4. The imaging device of claim 1, the photoreceptor assembly including:
a photoreceptor;
a charge unit for sensitizing the photoreceptor; and
an image exposure device for exposing an electrostatic latent image on the photoreceptor.

5. The imaging device of claim 4, the intermediate transfer assembly including:
a transfer belt having a circumferential working surface, the transfer belt having electrical properties that enable varied electrostatic fields about the circumferential working surface; and
a plurality of transfer rolls supporting said transfer belt, the transfer rolls being located proximally to said photoreceptor assembly and the transfer belt being biased to accommodate transfer of an electrostatic image from said photoreceptor to said transfer belt.

6. The imaging device of claim 1, the intermediate transfer assembly including:
a transfer belt; and
a plurality of transfer rolls supporting said transfer belt, the transfer rolls being located proximally to said photoreceptor assembly and the transfer rolls being biased to accommodate transfer of an electrostatic image from said photoreceptor to said transfer belt.

7. The imaging device of claim 5, the intermediate transfer assembly further including:
a developer assembly constructed and arranged to accommodate transfer of a toner complex to said transfer belt, the developer assembly being disposed a distance from the photoreceptor assembly.

8. The imaging device of claim 5, the intermediate transfer assembly further including:
a cleaning assembly for cleaning said transfer belt, the cleaning assembly being disposed a distance from the photoreceptor assembly.

9. The imaging device of claim 1, the toner image transfer assembly comprising:
a toner image transfer belt arranged to translate about at least one transfuse roll;
a media roller; and
a media feed, the toner image transfer belt constructed and arranged to accommodate carriage of media.

10. The imaging device of claim 9, the intermediate transfer assembly having a transfer belt supported by a transfer roll, the transfer roll being connected to a power supply and constructed and arranged to produce electrical field, said transfer roll being proximally located to said intermediate transfer assembly, said transfer roll and said transfer belt being interposed by said toner image transfer belt.

11. The imaging device of claim 9, the transfer roll including a heat source disposed a distance away from the photoreceptor assembly.

12. The imaging device of claim 5, at least one of said transfer rolls being connected to a heat source disposed a distance away from the photoreceptor assembly.

13. A method for imaging using a module and toner image transfer assembly, the module including a photoreceptor assembly and a transfer assembly, the method comprising:
producing and carrying a latent image on a photoreceptor;
transferring said latent image from said photoreceptor to said transfer assembly; and
transferring a toned image derived from said latent on said transfer assembly to said toner image transfer assembly, wherein said transfer assembly is disposed between said photoreceptor and said toner image transfer assembly.

14. The imaging method of claim 13, further comprising:
sensitizing a charge retentive surface of a photoreceptor;
image-wise exposing said charge retentive surface to produce an electrostatic latent image thereon;
transferring said electrostatic latent image from said charge retentive surface of the photoreceptor to an intermediate transfer belt having a frill conductive layer; and
carrying said electrostatic latent image via said transfer belt to a development assembly wherein a toner complex is deposited onto said latent image to produce a toned image, the development assembly being disposed a distance from the photoreceptor.

15. The imaging method of claim 14, comprising:
carrying said toned image having said toner complex deposited thereon to a transfuser assembly, said transfuser assembly being located distally from said charge retentive surface.

16. The imaging method of claim 15, comprising:
transferring said toned image having said toner complex deposited thereon to a medium carried by a toner image transfer belt disposed proximally to said intermediate transfer belt and a distance away from the photoreceptor.

17. The imaging method of claim 16, further comprising:
cleaning said intermediate transfer belt after transfer of said image having said toner complex deposited thereon, said cleaning assembly disposed proximally to said transfer belt and a distance away from the photoreceptor.

18. The imaging method of claim 16, further comprising:
carrying said medium via said toner image transfer belt to a second imaging module for application of a second color image to said medium.

19. The imaging device of claim 1, further comprising:
a second module in tandem with the first module, the first module providing a first color image to a medium carried by the toner image transfer belt, and the second imaging module providing a second color image to the medium carried by said toner image transfer belt.

20. A system for imaging comprising:
a photoreceptor means for producing and carrying a latent image;
an intermediate transfer means for accepting said latent image from said photoreceptor means; and
a transfuse means for accepting said toned image from said intermediate transfer means.
